(19) United States
(12) Patent Application Publication
(10) Pub. No.: US 2010/0284469 A1
(43) Pub. Date: Nov. 11, 2010

(54) Coding Device, Coding Method, Composite Device, and Composite Method

(76) Inventors: Kazushi Sato, Kanagawa (JP); Yoichi Yagasaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/812,675

(22) PCT Filed: Jan. 23, 2009
(86) PCT No.: PCT/JP2009/051029

§ 371 Date: Jul. 13, 2010

(30) Foreign Application Priority Data
Jan. 23, 2008 (JP) 2008-012947

(51) Int. Cl. G06K 9/36; H04N 7/26

(52) U.S. Cl. 375/240.16; 382/232; 382/238; 375/240.01; 382/233; 375/E07.123

(57) ABSTRACT

The present invention relates to an encoding device, an encoding method, a decoding device, and a decoding method which are capable of suppressing deterioration of compression efficiency.

The substitute block detector 64 detects, when blocks located adjacent to a block of interest to be subjected to encoding of an image have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks. The first encoder 63 encodes the block of interest by the first encoding method using the substitute blocks detected by the detector. The second encoder 66 encodes the block of interest which is not encoded by the first encoding method by the second encoding method.

### TECHNICAL FIELD

The present invention relates to encoding devices, encoding methods, decoding devices and decoding methods, and particularly relates to an encoding device, an encoding method, a decoding device, and a decoding method which suppress deterioration of compression efficiency.

### BACKGROUND ART

In recent years, a technique of performing compression encoding on an image using an MPEG (Moving Picture Experts Group) method or the like, packetizing and transmitting the image, and decoding the image on a receiver side has been widely used. By this, users may view high-quality moving images.

Here, it is possible that decoding is not performed since packets are lost in a transmission path or noise is superposed with the packets. Therefore, a technique of decoding a block of interest included in an image of a predetermined frame using blocks adjacent to the block of interest when the block of interest is not allowed to be decoded has been known (for example, Patent Document 1).
Patent Document 1: Japanese Unexamined Patent Application Publication No. 6-311502

### DISCLOSURE OF INVENTION

### Technical Problem

However, in the technique disclosed in Patent Document 1, although an image which is not allowed to be decoded may be restored, deterioration of encoding efficiency is not suppressed.

The present invention has been made to address this situation and suppress deterioration of compression efficiency.

### Technical Solution

According to an embodiment of the present invention, there is provided an encoding device including a detector which detects, when adjacent blocks located adjacent to a block of interest serving as a block to be subjected to encoding of an image have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks, a first encoder which encodes the block of interest by the first encoding method using the substitute blocks detected by the detector, and a second encoder which encodes the block of interest which is not encoded by the first encoding method by the second encoding method.

When co-located blocks which are included in pictures different from a picture including the block of interest and which are located in positions corresponding to the block of interest have been encoded by the first encoding method, the detector may detect the co-located blocks as substitute blocks.

When the adjacent blocks have been encoded by the first encoding method, the detector may detect the adjacent blocks as substitute blocks.

A determination unit which determines whether the block of interest is encoded by the first encoding method or the second encoding method may be additionally provided, and the second encoder may encode the block of interest which is determined to be encoded by the second encoding method by the determination unit.

The determination unit may determine blocks having parameter values representing differences between pixel values thereof and pixel values of the adjacent blocks larger than a threshold value as blocks to be encoded by the first encoding method and may determine blocks having the parameter values smaller than the threshold value as blocks to be encoded by the second encoding method.

The determination unit may determine blocks having edge information as blocks to be encoded by the first encoding method and determines blocks which do not have the edge information as blocks to be encoded by the second encoding method.

The determination unit may determine that I pictures and P pictures are encoded by the first encoding method and B pictures are encoded by the second encoding method.

The determination unit may determine that, among the blocks which do not have the edge information, blocks having the parameter values larger than the threshold value as blocks to be encoded by the first encoding method and the blocks having the parameter values smaller than the threshold value as blocks to be encoded by the second encoding method.

The determination unit may determine that, among the blocks which do not have the edge information of B pictures, the blocks having the parameter values larger than the threshold value as blocks to be encoded by the first encoding method and the blocks having the parameter values smaller than the threshold value as blocks to be encoded by the second encoding method.

The parameters may include dispersion values of pixel values included in the adjacent blocks.

The parameters may be represented by the following expression:

$$S T V = \frac{1}{N} {\sum }_{i = 1}^{N} [ {w}_{1} δ ( {B}_{i} ) + {w}_{2} {\sum }_{{B}_{j} ∈ {μ}_{6} ( {B}_{j} )} \vert E ( {B}_{j} ) - E ( {B}_{i} ) \vert ] \qquad [ Expression 1 ]$$

A motion vector detector which detects global motion vectors of the image may be additionally provided, the first encoder may perform encoding using the global motion vectors detected by the motion vector detector, and the second encoder may encode the global motion vectors detected by the motion vector detector.

The second encoder may encode position information representing positions of the blocks having the parameter values smaller than the threshold value.

The first encoding method may be based on the H.264/AVC standard.

The second encoding method may correspond to a texture analysis/synthesis encoding method.

According to another embodiment of the present invention, there is provided an encoding method, including a detector, a first encoder, and a second encoder. The detector detects, when blocks located adjacent to a block of interest to be subjected to encoding of an image have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks. The first encoder encodes the block of interest by the first encoding method using the substitute blocks detected by the detector. The second encoder encodes the block of interest which is not encoded by the first encoding method by the second encoding method.

According to still another embodiment of the present invention, there is provided a decoding device including a detector which detects, when blocks located adjacent to a block of interest to be subjected to encoding of an image have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks, a first decoder which decodes the block of interest which has been encoded by the first encoding method by a first decoding method corresponding to the first encoding method using the substitute blocks detected by the detector, and a second decoder which decodes the block of interest which has been encoded by the second encoding method by a second decoding method corresponding to the second encoding method.

The detector may detect the substitute blocks in accordance with position information representing positions of blocks encoded by the second encoding method.

The second decoder may decode the position information by the second decoding method and synthesizes the block of interest which has been encoded by the second encoding method using an image which has been decoded by the first decoding method.

According to a further embodiment of the present invention, there is provided a decoding method, including a detector, a first decoder, and a second decoder. The detector detects, when blocks located adjacent to a block of interest to be subjected to encoding have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks. The first decoder decodes the block of interest which has been encoded by the first encoding method by a first decoding method corresponding to the first encoding method using the substitute blocks detected by the detector. The second decoder decodes the block of interest which has been encoded by the second encoding method by a second decoding method corresponding to the second encoding method.

According to a still further embodiment of the present invention, the detector detects, when adjacent blocks located adjacent to a block of interest serving as a block to be subjected to encoding of an image have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks, the first encoder encodes the block of interest by the first encoding method using the substitute blocks detected by the detector, and the second encoder encodes the block of interest which is not encoded by the first encoding method by the second encoding method.

According to a yet further embodiment of the present invention, the detector detects, when blocks located adjacent to a block of interest to be subjected to encoding of an image have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks, the first decoder decodes the block of interest which has been encoded by the first encoding method by a first decoding method corresponding to the first encoding method using the substitute blocks detected by the detector, and a second decoder decodes the block of interest which has been encoded by the second encoding method by a second decoding method corresponding to the second encoding method.

### Advantageous Effects

According to the present invention, deterioration of compression efficiency is suppressed.

### BRIEF DESCRIPTION OF DRAWINGS

FIG. 1 is a block diagram illustrating a configuration of an encoding device according to an embodiment to which the present invention is applied.

FIG. 2 is a diagram illustrating a basic process of a motion threading.

FIG. 3A is a diagram illustrating a calculation of a motion vector.

FIG. 3B is a diagram illustrating calculations of motion vectors.

FIG. 4 is a diagram illustrating a result of the motion threading.

FIG. 5 is a flowchart illustrating an encoding process.

FIG. 6 is a flowchart illustrating a substitute block detecting process.

FIG. 7 is a diagram illustrating substitute blocks.

FIG. 8 is a block diagram illustrating a configuration of a first encoder according to the embodiment.

FIG. 9 is a flowchart illustrating a first encoding process.

FIG. 10 is a diagram illustrating intra prediction.

FIG. 11 is a diagram illustrating directions of the intra prediction.

FIG. 12A is a diagram illustrating a process performed when adjacent blocks are unavailable.

FIG. 12B is a diagram illustrating a process performed when adjacent blocks are unavailable.

FIG. 13 is a block diagram illustrating a configuration of a decoding device according to the embodiment to which the present invention is applied.

FIG. 14 is a flowchart illustrating a decoding process.

FIG. 15 is a diagram illustrating texture synthesis.

FIG. 16 is a block diagram illustrating a configuration of a first decoder according to the embodiment.

FIG. 17 is a flowchart illustrating a first decoding process.

FIG. 18 is a block diagram illustrating a configuration of an encoding device according to another embodiment to which the present invention is applied.

### EXPLANATION OF REFERENCE NUMERALS

51 ENCODING DEVICE, 61 A/D CONVERTER, 62 SCREEN SORTING BUFFER, 63 FIRST ENCODER, 64 SUBSTITUTE BLOCK DETECTOR, 65 DETERMINATION UNIT, 66 SECOND ENCODER, 67 OUTPUT UNIT, 71 BLOCK CLASSIFYING UNIT, 72 MOTION THREADING UNIT, 73 EXEMPLAR UNIT, 101 DECODING DEVICE, 111 STORAGE BUFFER, 112 FIRST DECODER, 113 SUBSTITUTE BLOCK DETECTOR, 114 SECOND DECODER, 115 SCREEN SORTING BUFFER, 116 D/A CONVERTER, 121 AUXILIARY INFORMATION DECODER, 122 TEXTURE SYNTHESIZER

### BEST MODES FOR CARRYING OUT THE INVENTION

Embodiments of the present invention will be described hereinafter with reference to the accompanying drawings.

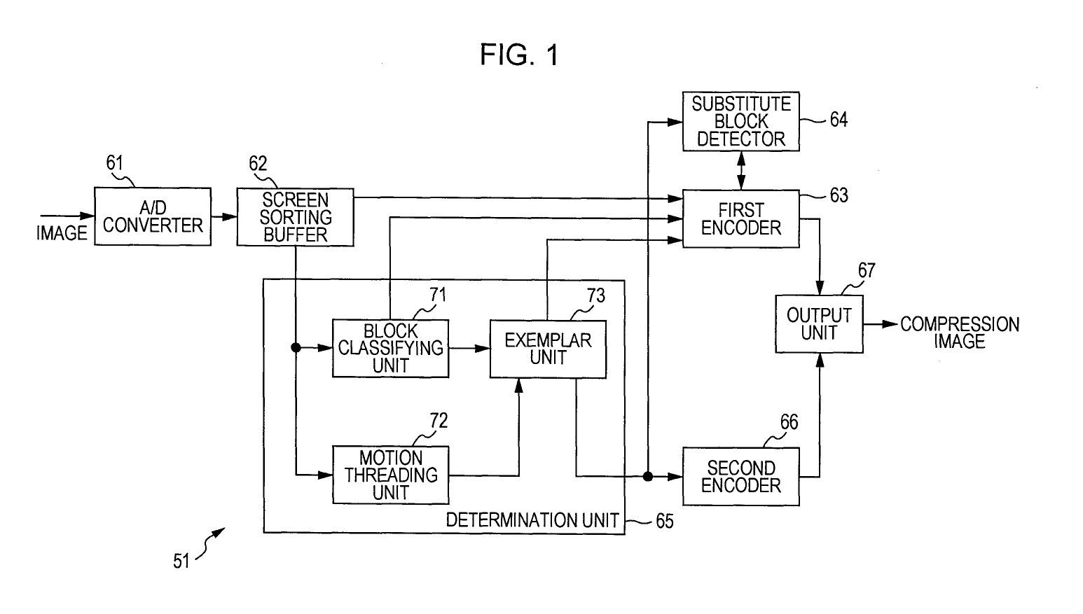

FIG. 1 is a block diagram illustrating a configuration of an encoding device according to an embodiment of the present invention. An encoding device 51 includes an A/D converter 61, a screen sorting buffer 62, a first encoder 63, a substitute block detector 64, a determination unit 65, a second encoder 66, and an output unit 67. The determination unit 65 includes a block classifying unit 71, a motion threading unit 72, and an exemplar unit 73.

The A/D converter 61 performs A/D conversion on an input image, and outputs the image to the screen sorting buffer 62 which stores the image. The screen sorting buffer 62 sorts images of frames which have been arranged in an order of storage in an order of encoding in accordance with GOP (Group of Picture). Among images stored in the screen sorting buffer 62, images of I pictures and P pictures are encoded in a first encoding method in advance and are supplied to the first encoder 63. Information on B pictures is supplied to the determination unit 65 which determines whether a block of interest of an image is to be subjected to encoding using a first encoding method or a second encoding method.

The block classifying unit 71 included in the determination unit 65 distinguishes blocks having edge information and blocks which do not have edge information in the images of the B pictures which have been supplied from the screen sorting buffer 62. The block classifying unit 71 outputs structural blocks having edge information as blocks to be subjected to a first encoding process to the first encoder 63 and supplies blocks which do not have edge information to the exemplar unit 73. The motion threading unit 72 detects motion threads of the images of the B pictures supplied from the screen sorting buffer 62 and supplies the motion threads to the exemplar unit 73.

The exemplar unit 73 calculates values of STVs of the blocks which do not have edge information in accordance with the motion threads using Equation (2) below and compares the values with a predetermined threshold value. When a value of an STV is larger than the threshold value, an image of a block of a B picture corresponding to the value is supplied to the first encoder 63 as an image of an exemplar serving as a block to be subjected to the first encoding process. When a value of an STV is smaller than the threshold value, the exemplar unit 73 determines that a block of a B picture corresponding to the value is a removal block serving as a block to be subjected to a second encoding process, and supplies a binary mask as positional information representing a position to the second encoder 66.

The first encoder 63 encodes the images of the I pictures and the P pictures supplied from the screen sorting buffer 62, the structural blocks supplied from the block classifying unit 71, and the images of the exemplars supplied from the exemplar unit 73 using a first encoding method. An example of the first encoding method includes H.264 and MPEG-4 Part 10 (Advanced Video Coding) (hereinafter referred to as “H.264/AVC”).

When blocks adjacent to a block of interest to be subjected to encoding using the first encoder 63 have been encoded by the second encoding method, the substitute block detector 64 detects blocks which are positioned closest to the block of interest in directions in which the block of interest is connected to the adjacent blocks and which have been encoded by the first encoding method as substitute blocks. The first encoder 63 encodes the block of interest by the first encoding method utilizing the substitute blocks as peripheral blocks.

The second encoder 66 encodes the binary masks supplied from the exemplar unit 73 by the second encoding method which is different from the first encoding method. An example of the second encoding method includes a texture analysis/synthesis coding method.

The output unit 67 synthesizes an output of the first encoder 63 and an output of the second encoder 66 with each other so as to output a compression image.

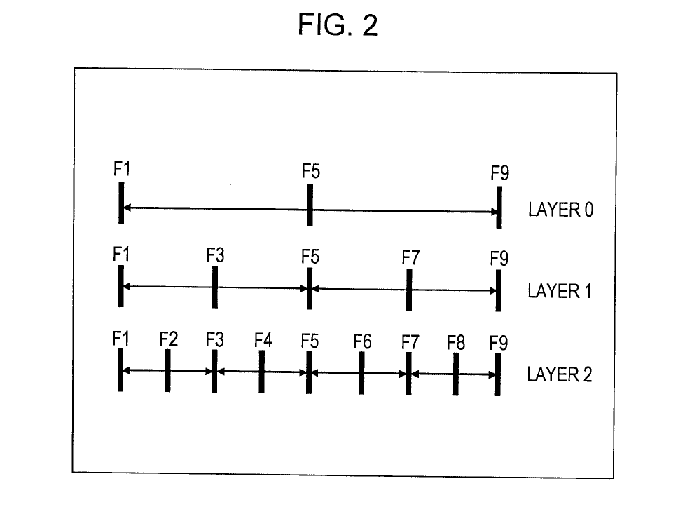

Here, a basic process performed by the motion threading unit 72 will be described. As shown in FIG. 2, the motion threading unit 72 divides an image in a unit of GOP so that a layer structure is obtained. In the embodiment shown in FIG. 2, GOPs each having a length of 8 are arranged in layers 0, 1, and 2 in a divided manner. The GOP length may be the power of 2, and the GOP length is not limited to this.

The layer 2 is an original GOP of an input image including nine frames, i.e., frames (or fields) F1 to F9. The layer 1 includes five frames, i.e., the frames F1, F3, F5, F7, and F9, obtained by thinning out the frames of the layer 2 every other frame. The layer 0 includes three frames, i.e., the frames F1, F5, and F9, obtained by thinning out the frames of the layer 1 every other frame.

The motion threading unit 72 obtains a motion vector in the uppermost layer (the layer denoted by the smallest number located in an upper portion in FIG. 2), and thereafter, obtains motion vectors in the next layer below utilizing the motion vector of the uppermost layer.

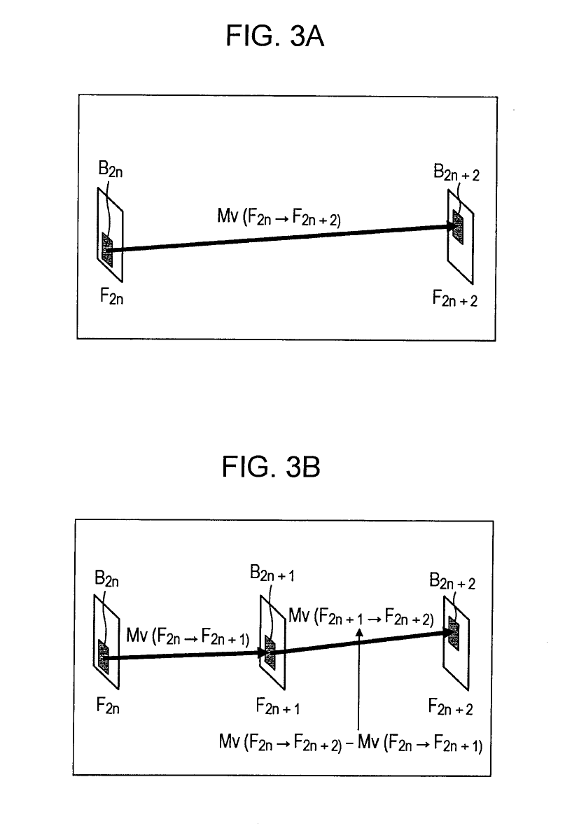

That is, as shown in FIG. 3A, the motion threading unit 72 calculates a motion vector Mv(F₂ₙ→F₂ₙ₊₂) between frames F₂ₙ and F₂ₙ₊₂ in the uppermost layer using a block matching method, for example, and in addition, calculates a block B₂ₙ₊₂ of the frame F₂ₙ₊₂ corresponding to a block B₂ₙ of the frame F₂ₙ.

Next, as shown in FIG. 3B, the motion threading unit 72 calculates a motion vector My (F₂ₙ→F₂ₙ₊₁) between the frame F₂ₙ and a frame F₂ₙ₊₁ (a frame between the frames F₂ₙ and F₂ₙ₊₂) using the block matching method, and in addition, calculates a block B₂ₙ₊₁ of the frame F₂ₙ₊₁ corresponding to the block B₂ₙ of the frame F₂ₙ.

Then, the motion threading unit 72 calculates a motion vector Mv(F₂ₙ₊₁→F₂ₙ₊₂) between the frames F₂ₙ₊₁ and F₂ₙ₊₂ using the following expression.

Mv(F₂ₙ₊₁→F₂ₙ₊₂)=Mv(F₂ₙ→F₂ₙ₊₂)−Mv(F₂ₙ→F₂ₙ₊₁) (1)

According to the principle described above, in the layer 0 of FIG. 2, a motion vector between the frames F5 and F9 is obtained using a motion vector between the frames F1 and F9 and a motion vector between the frames F1 and F5. Next, in the layer 1, a motion vector between the frames F1 and F3 is obtained, and a motion vector between the frames F3 and F5 is obtained using the motion vector between the frames F1 and F5 and the motion vector between the frames F1 and F3. A motion vector between the frames F5 and F7 is obtained, and a motion vector between the frames F7 and F9 is obtained using the motion vector between the frames F5 and F9 and the motion vector between the frames F5 and F7.

Furthermore, in the layer 2, a motion vector between the frames F1 and F2 is obtained, and a motion vector between the frames F2 and F3 is obtained using the motion vector between the frames F1 and F3 and the motion vector between the frames F1 and F2. A motion vector between the frames F3 and F4 is obtained, and a motion vector between the frames F4 and F5 is obtained using the motion vector between the frames F3 and F5 and the motion vector between the frames F3 and F4.

A motion vector between the frames F5 and F6 is obtained, and a motion vector between the frames F6 and F7 is obtained using the motion vector between the frames F5 and F7 and the motion vector between the frames F5 and F6. A motion vector between the frames F7 and F8 is obtained, and a motion vector between the frames F8 and F9 is obtained using the motion vector between the frames F7 and F9 and the motion vector between the frames F7 and F8.

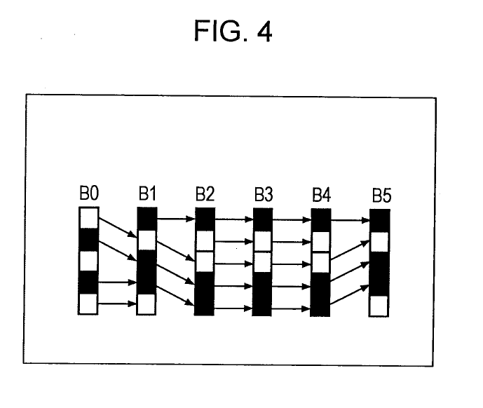

FIG. 4 is a diagram illustrating examples of motion threads calculated in accordance with the motion vectors obtained as described above. In FIG. 4, black blocks denote removal blocks which have been encoded using the second encoding method whereas white blocks denote blocks which have been encoded using the first encoding method.

In this example, the uppermost block included in a picture B0 belongs to a thread which includes the second position of a picture B1 from the top, the third position of a picture B2 from the top, the third position of a picture B3 from the top, the third position of a picture B4 from the top, and the second position of a picture B5 from the top.

Furthermore, a block located in the fifth position of the picture B0 from the top belongs to a thread including the fifth position of the picture B1 from the top.

As described above, a motion thread represents a miracle of positions of blocks included in corresponding pictures (i.e., a link of motion vectors).

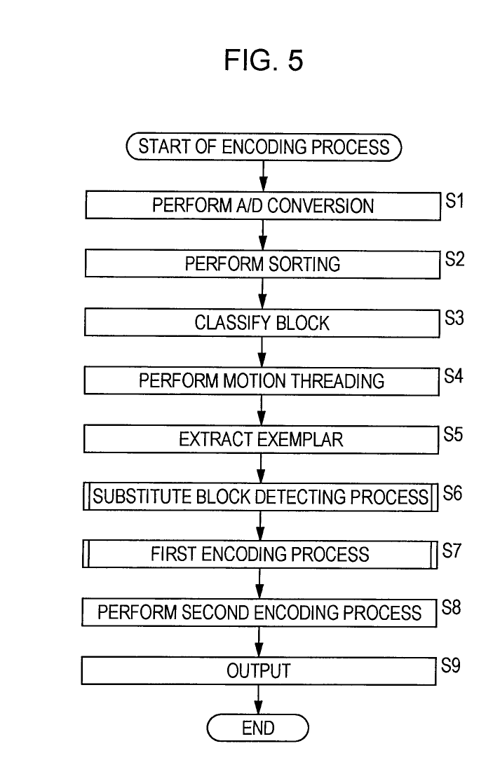

Next, an encoding process performed by the encoding device 51 shown in FIG. 1 will be described with reference to a flowchart shown in FIG. 5.

In step S1, the A/D converter 61 performs A/D conversion on an input image. In step S2, the screen sorting buffer 62 stores the image supplied from the A/D converter 61 and sorts pictures which have been arranged in order of display in order of encoding. Sorted I pictures and P pictures have been determined (decided), by the determination unit 65, as pictures to be subjected to the first encoding process and are supplied to the first encoder 63. B pictures are supplied to the block classifying unit 71 and the motion threading unit 72 which are included in the determination unit 65.

In step S3, the block classifying unit 71 classifies blocks of the input B pictures. Specifically, it is determined whether a block of each of the pictures which serves as a unit of encoding to be performed by the first encoder 63 (a macro block having a size of 16×16 pixels or smaller) includes edge information, and blocks including edge information larger than a preset reference value and blocks which do not include the edge information are distinguished from each other. Since the blocks including the edge information correspond to blocks of images which attract persons' eyes (that is, blocks to be subjected to the first encoding process), the blocks are supplied to the first encoder 63 as structural blocks. The images which do not include the edge information are supplied to the exemplar unit 73.

In step S4, the motion threading unit 72 performs motion threading on the B pictures. That is, as described with reference to FIGS. 2 to 4, a motion thread represents a miracle of positions of blocks and this information is supplied to the exemplar unit 73. The exemplar unit 73 calculates an STV which will be described below in accordance with this information.

In step S5, the exemplar unit 73 extracts exemplars. Specifically, the exemplar unit 73 calculates STVs in accordance with the following expression.

$$\begin{matrix}[ Expression 2 ] & \\ S T V = \frac{1}{N} {\sum }_{i = 1}^{N} [ {w}_{1} δ ( {B}_{i} ) + {w}_{2} {\sum }_{{B}_{j} ∈ {μ}_{6} ( {B}_{j} )} \vert E ( {B}_{j} ) - E ( {B}_{i} ) \vert ] & ( 2 )\end{matrix}$$

In the expression above, N denotes a length of a motion thread obtained by the motion threading unit 72, Bi denotes a block included in the motion thread, μ₆ denotes a block adjacent to the block in a temporal-spatial manner (upper, lower, right, and left spaces and preceding and succeeding time points), δ denotes a dispersion value of a pixel value included in the block, E denotes an average value of pixel values included in the block, and w1 and w2 denote predetermined weight coefficients.

Since a difference between a pixel value of a block having a large STV value and pixel values of adjacent blocks is large, the block having a large STV attracts persons' eyes (that is, the block to be subjected to the first encoding process). Therefore, the exemplar unit 73 determines a block having an STV value larger than a predetermined threshold value as an exemplar to be supplied to the first encoder 63.

As described above, the processes from step S2 to step S5 are performed so that the determination unit 65 determines whether encoding is performed by the first or second encoding method.

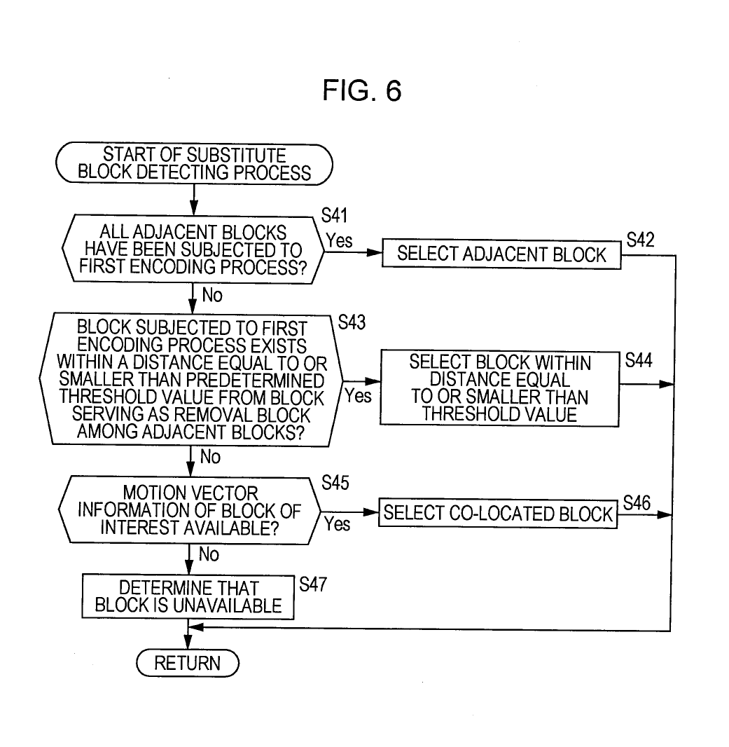

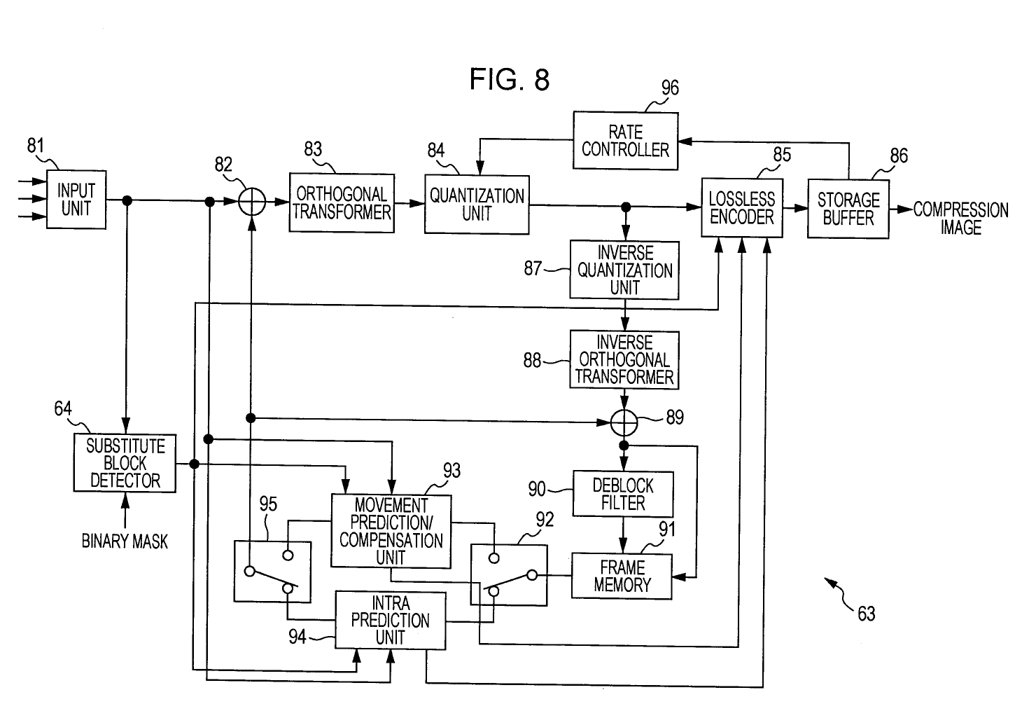

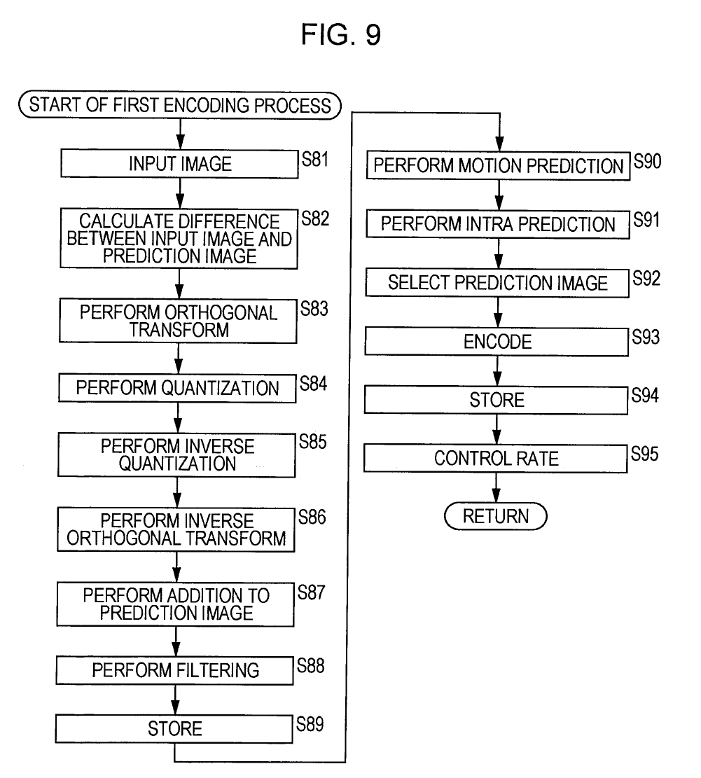

In step S6, the substitute block detector 64 executes a substitute block detecting process. The process will be described in detail hereinafter with reference to FIG. 6. Through this process, substitute blocks serving as peripheral information of a block of interest required for performing the first encoding process are detected. In step S7, the first encoder 63 performs the first encoding process. The process will be described in detail hereinafter with reference to FIGS. 8 and 9. Through this process, blocks which have been determined as blocks to be subjected to the first encoding process by the determination unit 65, i.e., the I pictures, the P pictures, the structural blocks, and the exemplars are encoded by the first encoding method utilizing the substitute blocks.

In step S8, the second encoder 66 encodes the binary masks of the removal blocks supplied from the exemplar unit 73 by the second encoding method. The removal blocks are not directly encoded by this process. However, since decoding is performed by synthesizing an image using a decoding device as will be described hereinafter, this process may be a type of encoding.

In step S9, the output unit 67 synthesizes a compression image which has been encoded by the first encoder 63 with information which has been encoded by the second encoder 66 and outputs a resultant image. The output is supplied through a transmission path to the decoding device which decodes the output.

Referring now to FIG. 6, the substitute block detecting process performed in step S6 will be described. As shown in FIG. 6, in step S41, the substitute block detector 64 determines whether all adjacent blocks have been subjected to the first encoding process.

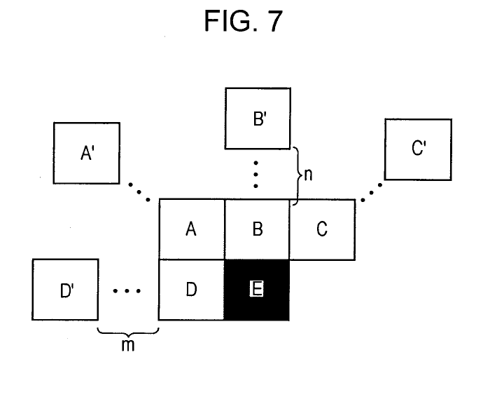

The encoding process is performed on the blocks in order from an upper left to a lower right of a screen. As shown in FIG. 7, it is assumed that a block of interest to be subjected to the encoding process is block E, a block A located on an upper left side of the block E, a block B located on an upper side of the block E, a block C located on an upper right side of the block E, and a block D located on a left side of the block E which are positioned adjacent to the block of interest E have been subjected to the encoding process. In step S41, it is determined whether all the adjacent blocks A to D has been encoded by the first encoder 63.

In a case where all the blocks A to D have been encoded by the first encoder 63, the substitute block detector 64 selects the adjacent blocks A to D as peripheral blocks in step S42. That is, before performing encoding on the block E, the first encoder 63 performs a prediction process in accordance with motion vectors of the adjacent blocks A to D. In this case, since the available blocks exist, efficient encoding may be performed.

Blocks which are not encoded by the first encoder 63 are determined as removal blocks and are encoded by the second encoder 66. In a case where the adjacent blocks A to D have been encoded by the second encoder 66 (in a case where the adjacent blocks A to D do not correspond to blocks which have been encoded by the first encoder 63), the first encoder 63 does not use the adjacent blocks A to D for the encoding of the block E since an encoding principle is different. In this case, if the encoding process is performed in an unavailable state in which any block serving as peripheral information is not obtained, that is, if a process the same as that performed when a block of interest is located at an edge portion of a screen and any adjacent block is not located around the block of interest is performed, encoding efficiency is deteriorated in the encoding process in this case when compared with the case where adjacent blocks exist.

Therefore, when all the adjacent blocks A to D have not been encoded by the first encoder 63, the first encoder 63 determines whether blocks which have been subjected to the first encoding process are included within a certain distance from the blocks determined as the removal blocks which correspond to predetermined threshold value in step S43. That is, it is determined whether substitute blocks for the adjacent blocks exist. Then, when blocks which have been subjected to the first encoding process exist within the distance corresponding to the predetermined threshold value (when substitute blocks exist), the substitute block detector 64 selects the substitute blocks positioned within the distance corresponding to the predetermined threshold value as peripheral blocks in step S44.

For example, as shown in FIG. 7, when the adjacent block A has not been encoded by the first encoder 63 (when the adjacent block A has been encoded by the second encoder 66), a block A′ which is positioned closest to the block E in a direction in which the block E is connected to the block A and which has been encoded by the first encoder 63 is determined as a substitute block.

Since the substitute block A′ is positioned near the adjacent block A, it is considered that the substitute block A′ has characteristics similar to those of the adjacent block A. That is, the substitute block A′ has a comparatively high correlation with the adjacent block A. Therefore, when the first encoding is performed on the block E using the substitute block A′ instead of the adjacent block A, that is, when a prediction process is performed using a motion vector of the substitute block A′, deterioration of coding efficiency may be suppressed.

Note that, when a distance between the substitute block A′ and the adjacent block A is equal to the predetermined threshold value or more, it is unlikely that the substitute block A′ corresponds to an image having characteristics similar to those of the adjacent block A (low correlation). As a result, even when the substitute block A′ located in a position equal to or father than the threshold value is used, it is difficult to suppress deterioration of encoding efficiency.

Therefore, only blocks positioned within the distance equal to or smaller than the threshold value are utilized as substitute blocks for encoding of the block E.

The same is applied to the adjacent blocks B to D, and when the adjacent blocks B to D are removal blocks, motion vectors of substitute blocks B′ to D′ which are positioned within distances equal to or smaller than the threshold value in directions from the block E to the adjacent blocks B to D are used for the first encoding of the block E instead of motion vectors of the adjacent blocks B to D.

Note that the threshold value of this distance may be a fixed value or may be determined by the user, encoded by the first encoder 63, and transmitted with the compression image.

In step S43, when any block which has been subjected to the first encoding process is not included within the distance equal to or smaller than the predetermined threshold value from the removal blocks among the adjacent blocks in step S43, it is determined whether a substitute process in relation to the motion vectors is available in step S45.

That is, the substitute block detector 64 determines whether motion vectors of co-located blocks are available in step S45. A co-located block corresponds to a block of a picture which is different from a picture including a block of interest (a picture positioned before or after the picture of the block of interest) and corresponds to a block located in a position corresponding to a position of the block of interest. If the co-located blocks have been subjected to the first encoding process, it is determined that motion vectors of the co-located blocks are available. In this case, in step S46, the substitute block detector 64 selects the co-located blocks as peripheral blocks. That is, the first encoder 63 performs the encoding process after performing the prediction process in accordance with the motion vectors of the co-located blocks serving as substitute blocks of the block of interest. By this, deterioration of encoding efficiency is suppressed.

When the motion vectors of the co-located blocks are not available, in step S47, the substitute block detector 64 determines that the blocks are unavailable. That is, in this case, a process the same as the conventional process is performed.

As described above, when the first encoding is to be performed on blocks of the images of the B pictures which attract persons' eyes in addition to the I pictures and the P pictures and when adjacent blocks corresponding to images which do not attract persons' eyes have been subjected to the second encoding, substitute blocks which have been subjected to the first encoding and which are located nearest a block of interest in directions from the block of interest to the adjacent blocks are used as peripheral blocks for the first encoding performed on the block of interest. Accordingly, deterioration of encoding efficiency is suppressed.

FIG. 8 is a diagram illustrating a configuration of the first encoder 63 according to the embodiment. The first encoder 63 includes an input unit 81, a calculation unit 82, an orthogonal transformer 83, a quantization unit 84, a lossless encoder 85, a storage buffer 86, an inverse quantization unit 87, an inverse orthogonal transformer 88, a calculation unit 89, a deblock filter 90, a frame memory 91, a switch 92, a motion prediction/compensation unit 93, an intra prediction unit 94, a switch 95, and a rate controller 96.

The input unit 81 receives images of I pictures and P pictures from the screen sorting buffer 62, images of structural blocks from the block classifying unit 71, and images of exemplars from the exemplar unit 73. The input unit 81 supplies each of the input images to the substitute block detector 64, the calculation unit 82, the motion prediction/compensation unit 93, and the intra prediction unit 94.

The calculation unit 82 subtracts a prediction image supplied from the motion prediction/compensation unit 93 or the intra prediction unit 94 which is selected using the switch 95 from an image supplied from the input unit 81, and outputs difference information to the orthogonal transformer 83. The orthogonal transformer 83 performs orthogonal transform such as discrete cosine transform or Karhunen-Loeve transform on the difference information supplied from the calculation unit 82 and outputs a transform coefficient thereof. The quantization unit 84 quantizes the transform coefficient output from the orthogonal transformer 83.

The quantized transform coefficient output from the quantization unit 84 is supplied to the lossless encoder 85 where the quantized transform coefficient is subjected to lossless encoding such as variable-length coding or arithmetic coding and is compressed. The compression image is stored in the storage buffer 86, and thereafter, is output. The rate controller 96 controls a quantization operation performed by the quantization unit 84 in accordance with the compression image stored in the storage buffer 86.

The quantized transform coefficient output from the quantization unit 84 is also supplied to the inverse quantization unit 87 where the quantized transform coefficient is subjected to inverse quantization and is further supplied to the inverse orthogonal transformer 88 where the transform coefficient is subjected to inverse orthogonal transform. The output which has been subjected to the inverse orthogonal transform is added to the prediction image supplied from the switch 95 using the calculation unit 89 so that an image in which a portion thereof is decoded is obtained. The deblock filter 90 removes block distortion of the decoded image, and thereafter, supplies the image to the frame memory 91 which stores the image. An image which has not been subjected to a deblock filter process by the deblock filter 90 is also supplied to the frame memory 91 which stores the image.

The switch 92 outputs a reference image stored in the frame memory 91 to the motion prediction/compensation unit 93 or the intra prediction unit 94. The intra prediction unit 94 performs an intra prediction process in accordance with the image to be subjected to intra prediction supplied from the input unit 81 and the reference image supplied from the frame memory 91 so as to generate the prediction image. Here, the intra prediction unit 94 supplies information on an intra prediction mode which has been applied to a block to the lossless encoder 85. The lossless encoder 85 encodes the information and adds the information to header information of the compression image as a portion of the information of the compression image.

The motion prediction/compensation unit 93 detects a motion vector in accordance with the image which is supplied from the input unit 81 and which is to be subjected to inter encoding and the reference image supplied from the frame memory 91 through the switch 92 and performs motion prediction and a compensation process on the reference image in accordance with the motion vector so as to generate the prediction image.

The motion prediction/compensation unit 93 outputs the motion vector to the lossless encoder 85. The lossless encoder 85 performs a lossless encoding process such as variable-length coding or arithmetic coding on the motion vector and inserts the motion vector into a header portion of the compression image.

The switch 95 selects the prediction image supplied from the motion prediction/compensation unit 93 or the intra prediction unit 94 and supplies the prediction image to the calculation units 82 and 89.

The substitute block detector 64 determines whether adjacent blocks are removal blocks in accordance with binary masks output from the exemplar unit 73. When the adjacent blocks are removal blocks, the substitute block detector 64 detects substitute blocks and supplies a result of the detection to the lossless encoder 85, the motion prediction/compensation unit 93, and the intra prediction unit 94.

Referring now to FIG. 9, the first encoding process performed by the first encoder 63 in step S7 of FIG. 5 will be described.

In step S81, the input unit 81 receives an image. Specifically, the input unit 81 receives images of I pictures and P pictures from the screen sorting buffer 62, images of structural blocks from the block classifying unit 71, and images of exemplars from the exemplar unit 73. In step S82, the calculation unit 82 calculates a difference between the image input in step S81 and a prediction image. The prediction image is supplied from the motion prediction/compensation unit 93 when inter prediction is to be performed or from the intra prediction unit 94 when intra prediction is to be performed through the switch 95 to the calculation unit 82.

An amount of difference data is smaller than that of data of the original image. Therefore, an amount of data can be compressed when compared with a case where the original image is encoded.

In step S83, the orthogonal transformer 83 performs orthogonal transform on information on the difference supplied from the calculation unit 82. Specifically, orthogonal transform such as cosine transform or Karhunen-Loeve transform is performed so that a transform coefficient is obtained. In step S84, the quantization unit 84 quantizes the transform coefficient. In the quantization, a rate is controlled as will be described in a process performed in step S95.

The difference information quantized as described above is partially decoded as follows. That is, in step S85, the inverse quantization unit 87 performs inverse quantization on the transform coefficient which has been quantized by the quantization unit 84 using characteristics corresponding to characteristics of the quantization unit 84. In step S86, the inverse orthogonal transformer 88 performs inverse orthogonal transform on the transform coefficient which has been subjected to the inverse quantization by the inverse quantization unit 87 using characteristics corresponding to characteristics of the orthogonal transformer 83.

In step S87, the calculation unit 89 adds the prediction image input through the switch 95 to the partially-decoded difference information so as to generate a partially-decoded image (an image corresponding to the input to the calculation unit 82). In step S88, the deblock filter 90 performs filtering on the image output from the calculation unit 89. By this, block distortion is removed. In step S89, the frame memory 91 stores the image which has been subjected to the filtering. Note that the frame memory 91 also stores an image which has not been subjected to the filtering by the deblock filter 90 and which is supplied from the calculation unit 89.

In a case where an image to be processed which has been supplied from the input unit 81 corresponds to an image to be subjected to an inter process, a reference image is read from the frame memory 91 and supplied to the motion prediction/compensation unit 93 through the switch 92. In step S90, the motion prediction/compensation unit 93 predicts a motion with reference to the image supplied from the frame memory 91 and performs motion compensation in accordance with the motion so as to generate a prediction image.

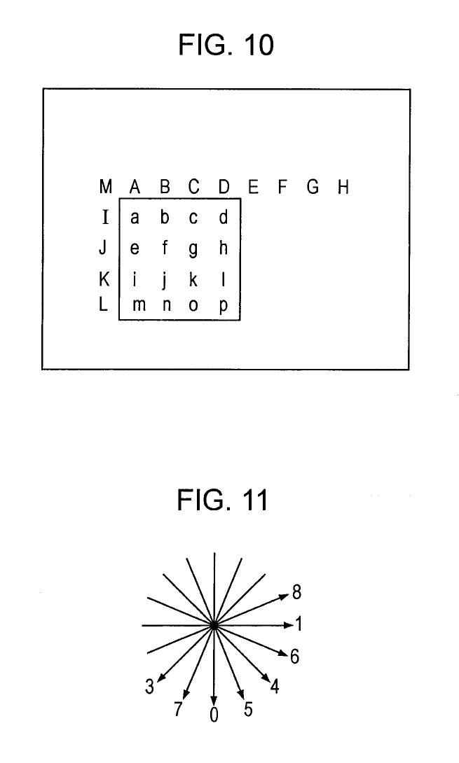

The image to be processed (pixels a to p in FIG. 10, for example) which has been supplied from the input unit 81 corresponds to an image of a block to be subjected to an intra process, a reference image (pixels A to L in FIG. 10) which has been decoded is read from the frame memory 91 and supplied to the intra prediction unit 94 through the switch 92. In accordance with these images, in step S91, the intra prediction unit 94 performs intra prediction on pixels of a block to be processed in a predetermined intra prediction mode. Note that, as the reference pixels (the pixels A to L in FIG. 10) which have been decoded, pixels which have not been subjected to deblock filtering by the deblock filter 90 are used. This is because the intra prediction is sequentially performed on individual macro blocks whereas the deblock filtering process is performed after a series of decoding processes are performed.

As an intra prediction mode for brightness signals, prediction modes of nine types of block unit having 4×4 pixels and 8×8 pixels and four types of macro block unit having 16×16 pixels are provided. As an intra prediction mode for color-difference signals, prediction modes of four types of block unit having 8×8 pixels are provided. The intra prediction modes for color-difference signals may be set separately from the intra prediction modes for brightness signals. As for the intra prediction modes for bright signals for 4×4 pixels and 8×8 pixels, one intra prediction mode is defined per block of a brightness signal having 4×4 pixels and 8×8 pixels. As for the intra prediction modes for brightness signals for 16×16 pixels and the intra prediction modes for color-difference signals, one prediction mode is defined per macro block.

The types of prediction mode correspond to directions denoted by numbers 0 to 8 shown in FIG. 11. A prediction mode 2 corresponds to average value prediction.

In step S92, the switch 95 selects a prediction image. That is, when the inter prediction is performed, the prediction image of the motion prediction/compensation unit 93 is selected whereas when the intra prediction is performed, the prediction image of the intra prediction unit 94 is selected. The selected image is supplied to the calculation units 82 and 89. The prediction image is used in the calculation performed in step S82 and step S87 described above.

In step S93, the lossless encoder 85 encodes the quantized transform efficient which has been output from the quantization unit 84. That is, a difference image is subjected to lossless encoding such as variable-length encoding or arithmetic coding and compressed. Note that, here, the motion vector detected by the motion prediction/compensation unit 93 in step S90 and information on the intra prediction mode applied to the block by the intra prediction unit 94 in step S91 are also encoded and added to the header information.

In step S94, the storage buffer 86 stores the difference image as a compression image. The compression image stored in the storage buffer 86 is appropriately read and supplied to a decoding side through a transmission path.

In step S95, the rate controller 96 controls a rate of the quantization operation performed by the quantization unit 84 in accordance with the compression image stored in the storage buffer 86 so as not to cause overflow or underflow.

In the motion prediction process, the intra prediction process, and the encoding process performed in step S90, step S91, and step S93, respectively, the peripheral blocks selected in step S44 and step S46 in FIG. 6 are utilized. That is, the prediction process is performed using motion vectors of substitute blocks selected instead of the adjacent blocks. Accordingly, when all the adjacent blocks have not been subjected to the first encoding process, the blocks are efficiently subjected to the first encoding process when compared with a case where the process is performed while the peripheral information is unavailable as with the process in step S47.

A process performed in the case where the peripheral information is unavailable will now be described.

First, a process performed when the peripheral information is unavailable in the intra prediction will be described taking an intra 4×4 mode as an example.

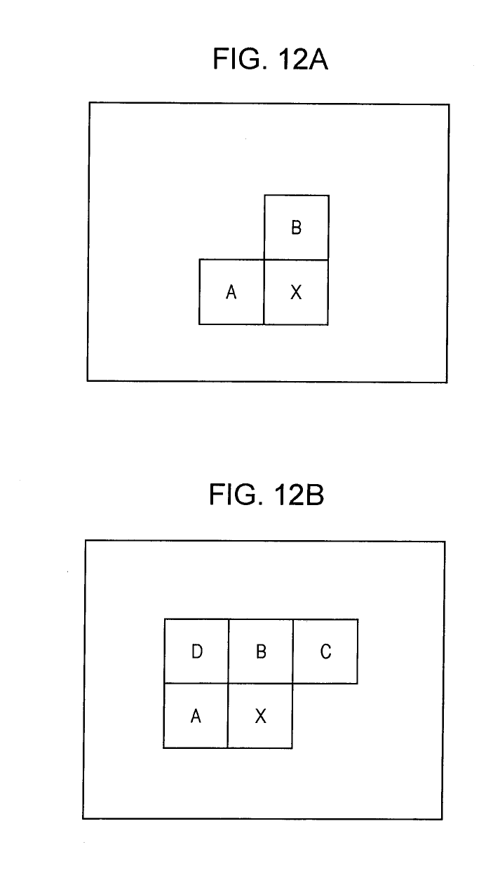

It is assumed that, in FIG. 12A, X denotes a 4×4 block of interest and A and B denote 4×4 blocks which are adjacent to the left side and the upper side of the block X, respectively. When one of the blocks A and B is unavailable, a flag dcPredModePredictedF1ag is equal to 1. Here, a prediction mode of the block of interest X is the prediction mode 2 (average value prediction mode). That is, a block including pixels having an average value of pixel values of the block of interest X is determined as a prediction block.

Even when the block of interest X is in an intra 8×8 prediction mode or an intra 16×16 prediction mode, or when the block of interest X corresponds to a block of a color-difference signal, the same process is performed for obtaining a motion prediction mode.

In motion vector encoding, when the peripheral information is unavailable, a process described below is performed.

It is assumed that, in FIG. 12B, X denotes a prediction block of interest, A to D denote motion prediction blocks which are adjacent to the block X on the left side, the upper side, the upper right side, and the upper left side, respectively. When motion vectors of the motion prediction blocks A to D are available, a prediction value PredMV of a motion vector to the motion prediction block X is generated using a median of the motion vectors of the motion prediction blocks A to C.

On the other hand, when one of the motion vectors of the motion prediction blocks A to D is unavailable, the following process is performed.

First, when the motion vector of the block C is unavailable and the motion vectors of the blocks A, B, and D are available, the motion vector of the block X is generated using a median of the motion vectors of the blocks A, B, and D. When both of the blocks B and C are unavailable, or both of the blocks C and D are unavailable, median prediction is not performed and the motion vector of the block A is determined as a prediction value of the motion vector of the block X. Note that, when the motion vector of the block A is unavailable, the prediction value of the motion vector of the block X is 0.

Next, a process of the variable-length encoding performed when the peripheral information is unavailable will be described.

In FIG. 12A, it is assumed that X denotes a 4×4 orthogonal transform block of interest or an 8×8 orthogonal transform block of interest, and A and B denote adjacent blocks. Assuming that the numbers of orthogonal transform coefficients in the blocks A and B which are not a value 0 are represented by nA and nB, a variable length transform table for the block X is selected using the numbers nA and nB. However, when the block A is unavailable, the number nA is determined to 0 and when the block B is unavailable, the number nB is determined to 0, and suitable transform tables is selected.

When the peripheral information is unavailable, a calculation encoding process is performed as follows.

Here, although a flag mb_skip_flag is taken as an example, other syntax elements are similarly processed.

A context ctx(K) is defined for a macro block K as described below. That is, when the macro block K corresponds to a skipped macro block in which a pixel located in a spatially-corresponding position in a reference frame is used without change, the context ctx(K) is determined to 1 and otherwise the context ctx(K) is determined to 0.

$$\begin{matrix}[ Expression 3 ] & \\ ctx ( K ) = \{ \begin{matrix}1 : if ( K == Skip ) \\ 0 : Otherwise\end{matrix} & ( 3 )\end{matrix}$$

A context ctx(X) for the block X of interest is calculated as a sum of a context ctx(A) of the block A which is adjacent to the block X on the left side and a context ctx(B) of the block B which is adjacent to the block X on the upper side as shown in the following equation.

ctx(X)=ctx(A)+ctx(B) (4)

When the block A or the block B is unavailable, the context ctx(A) is equal to 0 or the context ctx(B) is equal to 0.

As described above, when the process is performed while the peripheral information is unavailable, it is difficult to efficiently perform a process. However, when the substitute blocks are used as peripheral blocks as described above, an efficient process is attained.

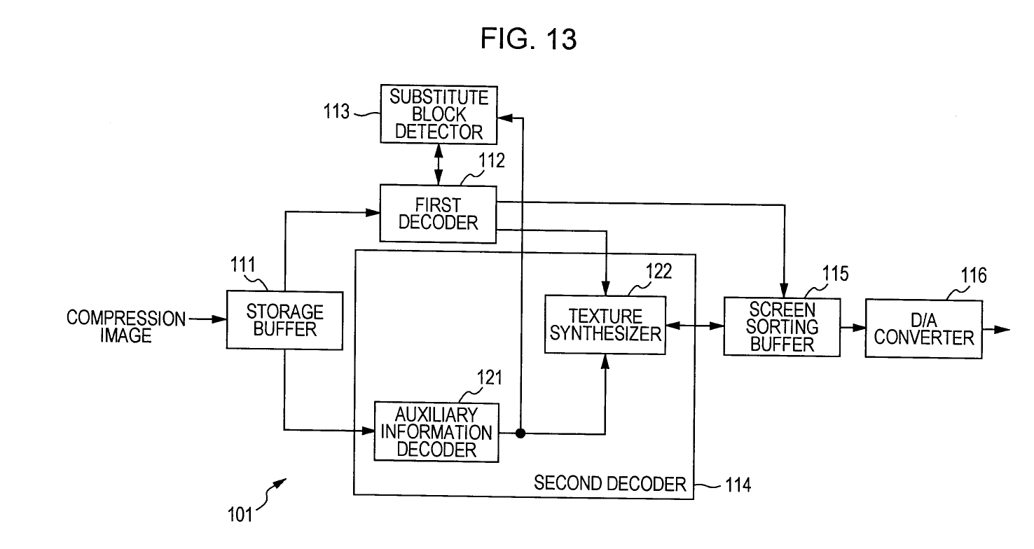

The compression image which has been encoded is transmitted through the predetermined transmission path and encoded by the decoding device. FIG. 13 illustrates a configuration of the decoding device according to the embodiment.

A decoding device 101 includes a storage buffer 111, a first decoder 112, a substitute block detector 113, a second decoder 114, a screen sorting buffer 115, and a D/A convertor 116. The second decoder 114 includes an auxiliary information decoder 121 and a texture synthesizer 122.

The storage buffer 111 stores transmitted compression images. The first decoder 112 decodes compression images which have been subjected to the first encoding among the compression images stored in the storage buffer 111 by a first decoding process. The first decoding process corresponds to the first encoding process performed by the first encoder 63 included in the encoding device 51 shown in FIG. 1. That is, the first decoding process is corresponds to a process employing a decoding method corresponding to an H.264/AVC method. The substitute block detector 113 detects substitute blocks in accordance with binary masks supplied from the auxiliary information decoder 121. This function is the same as that of the substitute block detector 64 shown in FIG. 1.

The second decoder 114 performs a second decoding process on the compression image which has been subjected to the second encoding and which has been supplied from the storage buffer 111. Specifically, the auxiliary information decoder 121 performs a decoding process corresponding to the second encoding process performed by the second encoder 66 shown in FIG. 1, and the texture synthesizer 122 performs a texture synthesizing process in accordance with the binary masks supplied from the auxiliary information decoder 121. Therefore, an image of a frame of interest (an image of a B picture) is supplied from the first decoder 112 to the texture synthesizer 122, and a reference image is supplied from the screen sorting buffer 115 to the texture synthesizer 122.

The screen sorting buffer 115 sorts images of I pictures and P pictures which have been decoded by the first decoder 112 and images of B pictures which have been synthesized by the texture synthesizer 122. That is, frames which have been sorted in order of encoding by the screen sorting buffer 62 are sorted in order of display which is an original state. The D/A convertor 116 performs D/A conversion on images supplied from the screen sorting buffer 115 and outputs the images to a display, not shown, which displays the images.

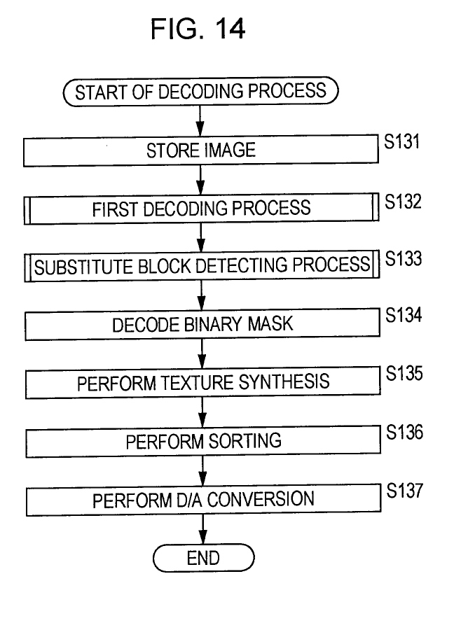

Referring now to FIG. 14, the decoding process performed by the decoding device 101 will be described.

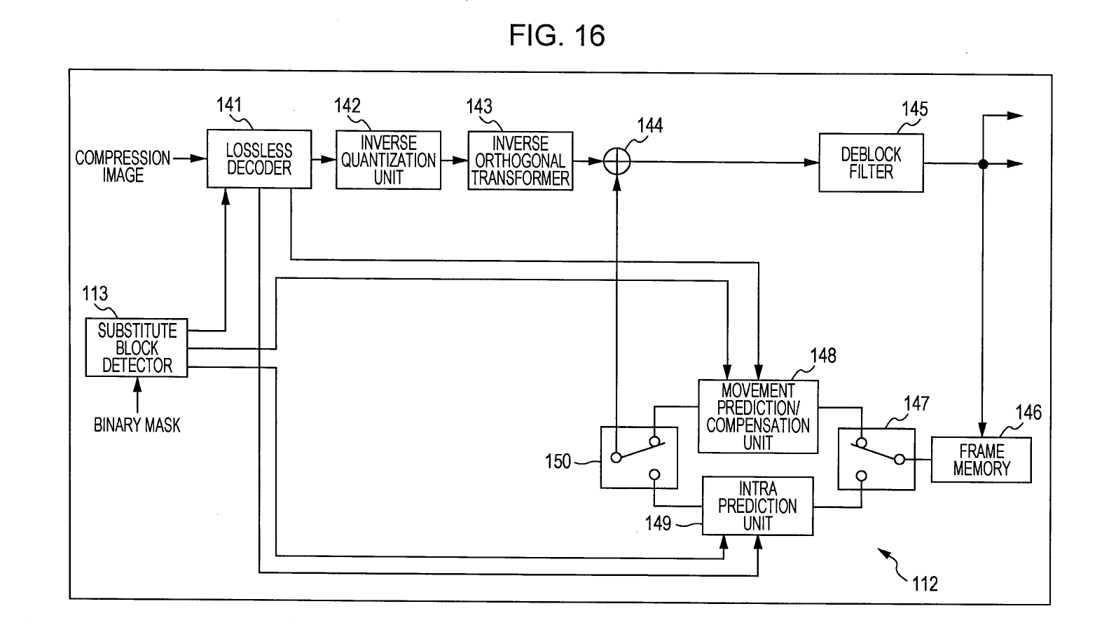

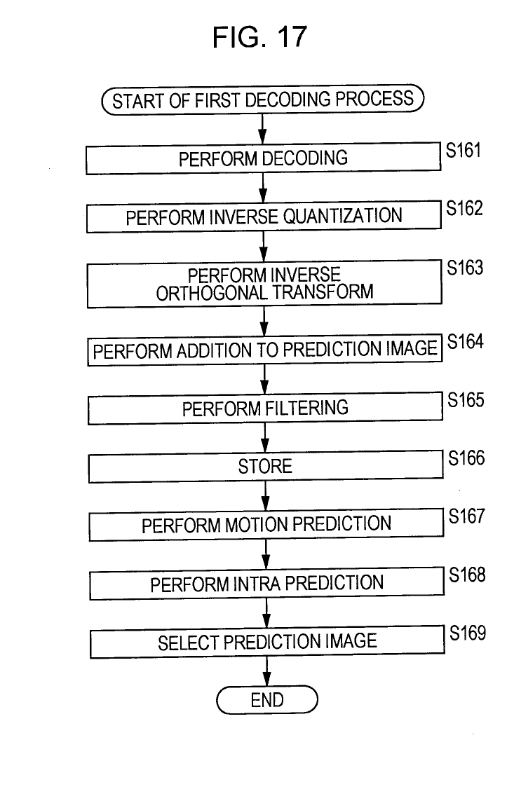

In step S131, the storage buffer 111 stores transmitted images. In step S132, the first decoder 112 performs the first decoding process on images which have been subjected to the first encoding process and which are read from the storage buffer 111. Although this process will be described in detail hereinafter with reference to FIGS. 16 and 17, the images of the I pictures and the P pictures which have been encoded by the first encoder 63, images of structural blocks of the B pictures, and images of exemplars (images corresponding blocks having STV values larger than a threshold value) are decoded. The images of the I pictures and the P pictures are supplied to the screen sorting buffer 115 and stored therein. The images of the B pictures are supplied to the texture synthesizer 122.

In step S133, the substitute block detector 113 executes a substitute block detecting process. This process is the same as that described with reference to FIG. 6. When adjacent blocks have not been subjected to the first encoding, substitute blocks are detected. To perform this process, the binary masks which have been decoded by the auxiliary information decoder 121 in step S134 which will be described hereinafter are supplied to the substitute block detector 113. The substitute block detector 113 determines whether individual blocks have been subjected to the first encoding process or the second encoding process using the binary masks. The first decoding process is performed in step S132 using the detected substitute blocks.

Next, the second decoder 114 performs second decoding in step S134 and step S135. That is, in step S134, the auxiliary information decoder 121 decodes the binary masks which have been subjected to the second encoding process and which are supplied from the storage buffer 111. The decoded binary masks are output to the texture synthesizer 122 and the substitute block detector 113. The binary masks represent positions of removal blocks, i.e., positions of blocks which have not been subjected to the first encoding process (positions of blocks which have been subjected to the second encoding process). Therefore, as described above, the substitute block detector 113 detects substitute blocks using the binary masks.

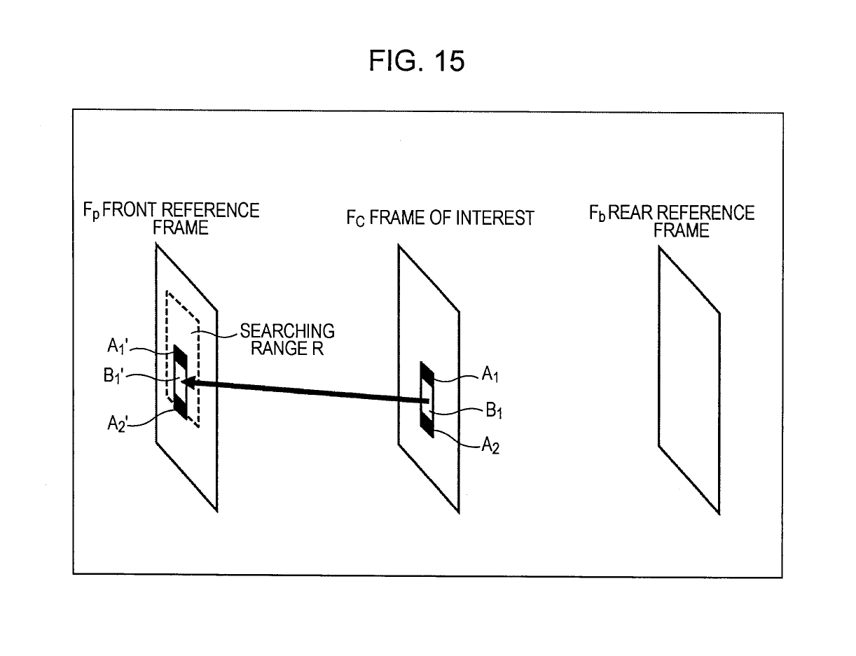

In step S135, the texture synthesizer 122 performs texture synthesis on the removal blocks specified by the binary masks. The texture synthesis is performed to restore the removal blocks (blocks of images having STV values smaller than the threshold value), and a principle thereof is shown in FIG. 15. As shown in FIG. 15, it is assumed that a frame of a B picture including a block of interest B1 which is a block to be subjected to the decoding process is a frame of interest F_{c}. When the block of interest B₁ is a removal block, a position thereof is represented by a binary mask.

When receiving the binary masks from the auxiliary information decoder 121, the texture synthesizer 122 sets a searching range R in a predetermined range included in a front reference frame F located in front of the frame of interest F_{c} so that the searching range R includes a position corresponding to the block of interest at the center thereof. The frame of interest F_{c} is supplied from the first decoder 112 to the texture synthesizer 122 and the front reference frame Fₚ is supplied from the screen sorting buffer to the texture synthesizer 122. Then, the texture synthesizer 122 searches the searching range R for a block B₁′ which has the highest correlation with the block of interest B₁. Note that the block of interest B₁ is a removal block, and therefore, is not subjected to the first encoding process. Accordingly, the block of interest B₁ does not have a pixel value.

Therefore, the texture synthesizer 122 uses pixel values of regions in a predetermined range in the vicinity of the block of interest B₁ for the searching instead of the pixel value of the block of interest B₁. In the case of this embodiment shown in FIG. 15, a pixel value of a region A₁ which is adjacent to the block of interest B₁ on the upper side of the block of interest B₁ and a pixel value of a region A₂ which is adjacent to the block of interest B₁ on the lower side of the block of interest B₁ are used. Assuming that a reference block B₁′ and regions A₁′ and A₂′ in the front reference frame Fₚ correspond to the block of interest B₁ and the regions A₁ and A₂, respectively, the texture synthesizer 122 calculates sums of absolute values of differences or square sums of differences between the regions A₁ and A₁′ and between the regions A₂ and A₂′ in a range in which the reference block B₁′ is positioned within the searching region R.

Similar calculations are performed for a rear reference frame F_{b} located one frame after the frame of interest F_{c}. The rear reference frame F_{b} is also supplied from the screen sorting buffer 115 to the texture synthesizer 122. Then, a reference block B₁′ which corresponds to regions A₁′ and A₂′ and which is located in a position corresponding to the smallest calculation value (the highest correlation) is searched for, and the reference block B₁′ is synthesized as a pixel value of the block of interest B₁ of the frame of interest F_{c}. The B picture in which the removal block has been synthesized is supplied to the screen sorting buffer 115 which stores the B picture.

As described above, since the second encoding method and the second decoding method of this embodiment corresponds to a texture analysis/synthesis encoding method and a texture analysis/synthesis decoding method, respectively, only the binary masks serving as auxiliary information are encoded and transmitted, but the pixel value of the block of interest is not directly encoded and transmitted. However, the block of interest is synthesized in accordance with the binary masks in the decoding device.

In step S136, the screen sorting buffer 115 performs sorting. That is, the frames which have been sorted by the screen sorting buffer 62 in order of encoding are sorted in order of display which is in an original state.

In step S137, the D/A convertor 116 performs D/A conversion on an image supplied from the screen sorting buffer 115. The image is output to the display, not shown, which displays the image.

FIG. 16 illustrates a configuration of the first decoder 112 according to the embodiment. The first decoder 112 includes a lossless decoder 141, an inverse quantization unit 142, an inverse orthogonal transformer 143, a calculation unit 144, a deblock filter 145, a frame memory 146, a switch 147, a motion prediction/compensation unit 148, an intra prediction unit 149, and a switch 150.

The lossless decoder 141 decodes information which has been encoded by the lossless encoder 85 shown in FIG. 8 by a method corresponding to the encoding method of the lossless encoder 85. The inverse quantization unit 142 performs inverse quantization on an image which has been decoded by the lossless decoder 141 by a method corresponding to the quantization method of the quantization unit 84 shown in FIG. 8. The inverse orthogonal transformer 143 performs inverse orthogonal transform on an output of the inverse quantization unit 142 by a method corresponding to the orthogonal transform method of the orthogonal transformer 83 shown in FIG. 8.

The output which has been subjected to the inverse orthogonal transform is decoded by being added to a prediction image supplied from the switch 150 using the calculation unit 144. The deblock filter 145 removes block distortion of the decoded image, and thereafter, supplies the image to the frame memory 146 which stores the image. In addition, the deblock filter 145 outputs B pictures to the texture synthesizer 122 shown in FIG. 13 and I pictures and P pictures to the screen sorting buffer 115.

The switch 147 reads an image to be subjected to inter encoding and a reference image from the frame memory 146, outputs the images to the motion prediction/compensation unit 148, reads an image used for intra prediction from the frame memory 146, and supplies the image to the intra prediction unit 149.

The intra prediction unit 149 receives information on an intra prediction mode obtained by decoding the header information from the lossless decoder 141. The intra prediction unit 149 generates a prediction image in accordance with this information.

The motion prediction/compensation unit 148 receives motion vectors obtained by decoding the header information from the lossless decoder 141. The motion prediction/compensation unit 148 performs motion prediction and a compensation process on the image in accordance with the motion vectors so as to generate a prediction image.

The switch 150 selects the prediction image generated by the motion prediction/compensation unit 148 or the intra prediction unit 149 and supplies the prediction image to the calculation unit 144.

The substitute block detector 113 detects substitute blocks in accordance with the binary masks output from the auxiliary information decoder 121 shown in FIG. 13, and outputs a result of the detection to the motion prediction/compensation unit 148 and the intra prediction unit 149.

Referring now to FIG. 17, a first decoding process performed by the first decoder 112 shown in FIG. 16 in step S132 of FIG. 14 will be described.

In step S161, the lossless decoder 141 decodes a compression image supplied from the storage buffer 111. That is, I pictures, P pictures, and structural blocks and exemplars of B pictures which have been encoded by the lossless encoder 85 shown in FIG. 8 are decoded. Here, motion vectors and an intra prediction mode are also decoded.

The motion vectors are supplied to the motion prediction/compensation unit 148 and the intra prediction mode is supplied to the intra prediction unit 149.

In step S162, the inverse quantization unit 142 performs inverse quantization on a transform coefficient which has been decoded by the lossless decoder 141 using characteristics corresponding to the characteristics of the quantization unit 84 shown in FIG. 8. In step S163, the inverse orthogonal transformer 143 performs inverse orthogonal transform on the transform coefficient which has been subjected to the inverse quantization by the inverse quantization unit 142 using characteristics corresponding to the characteristics of the orthogonal transformer 83 shown in FIG. 8. In this way, difference information corresponding to an input of the orthogonal transformer 83 (an output of the calculation unit 82) shown in FIG. 8 is decoded.

In step S164, the calculation unit 144 adds a prediction image which is selected in a process performed in step S169 which will be described hereinafter and which is input through the switch 150 to the difference information. In this way, an original image is obtained by decoding. In step S165, the deblock filter 145 performs filtering on an image output from the calculation unit 144. By this, block distortion is removed. Among images output from the calculation unit 144, B pictures are supplied to the texture synthesizer 122 shown in FIG. 13, and I pictures and P pictures are supplied to the screen sorting buffer 115. In step S166, the frame memory 146 stores the image which has been filtered.

When an image to be processed corresponds to an image to be subjected to an inter process, a required image is read from the frame memory 146 and is supplied to the motion prediction/compensation unit 148 through the switch 147. In step S167, the motion prediction/compensation unit 148 performs motion prediction in accordance with motion vectors supplied from the lossless decoder 141 so as to generate a prediction image.

When an image to be processed corresponds to an image to be subjected to an intra process, a required image is read from the frame memory 146 and is supplied to the intra prediction unit 149 through the switch 147. In step S168, the intra prediction unit 149 performs intra prediction in accordance with an intra prediction mode supplied from the lossless decoder 141 so as to generate a prediction image.

In step S169, the switch 150 selects a prediction image. That is, the prediction image generated by the motion prediction/compensation unit 148 or the prediction image generated by the intra prediction unit 149 is selected, is supplied to the calculation unit 144, and is added to the output of the inverse orthogonal transformer 143 in step S164 as described above.

Note that, in the decoding process performed by the lossless decoder 141 in step S161, the motion prediction/compensation process performed by the motion prediction/compensation unit 148 in step S167, and the intra prediction process performed by the intra prediction unit 149 in step S168, substitute blocks detected by the substitute block detector 113 are used. Accordingly, an efficient process is achieved.

The process described above is performed in step S132 of FIG. 14. This decoding process is basically the same as the portion decoding process performed by the first encoder 63 shown in FIG. 8 in step S85 to step S92 of FIG. 9.

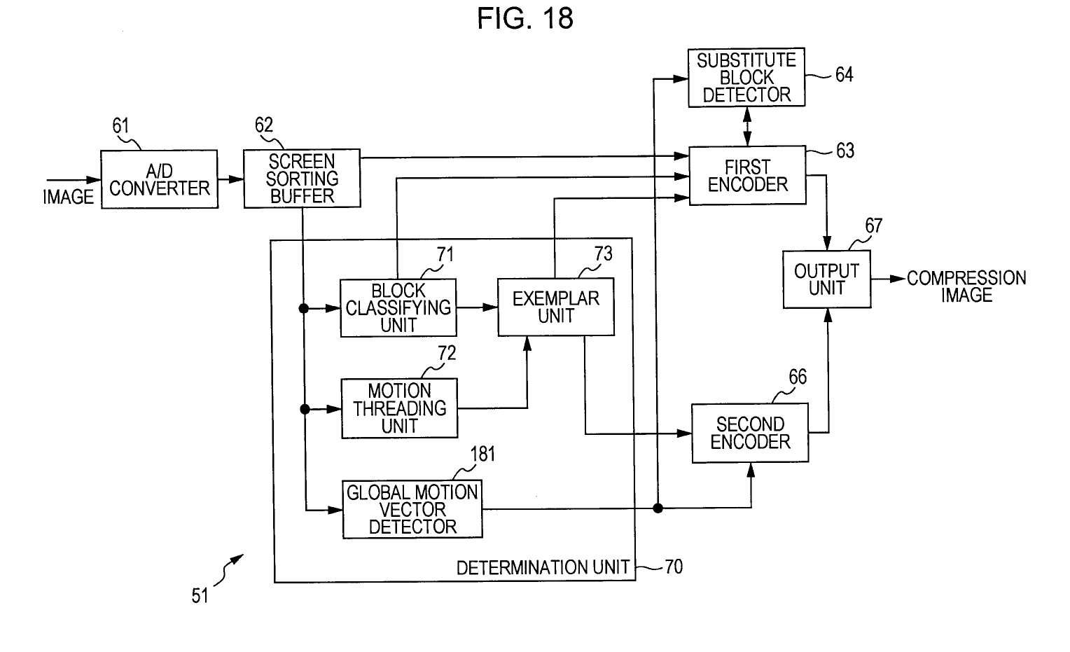

FIG. 18 illustrates a configuration of an encoding device according to another embodiment. A determination unit 70 included in this encoding device 51 additionally includes a global motion vector detector 181. The global motion vector detector 181 detects global motions such as parallel movement, enlargement, reduction of a size, and rotation of an entire screen of a frame supplied from the screen sorting buffer 62. Furthermore, the global motion vector detector 181 supplies global motion vectors corresponding to results of detections to the substitute block detector 64 and the second encoder 66.

The substitute block detector 64 detects substitute blocks by performing parallel movement, enlargement, reduction of a size, and rotation on the entire screen in accordance with the global motion vectors so as to obtain an original. By this, even when the entire screen has been subjected to parallel movement, enlargement, reduction of a size, and rotation, substitute blocks are reliably detected.

A second encoder 66 performs a second encoding process on the global motion vectors as well as binary masks, and transmits the binary masks and the global motion vectors to a decoding side.

Other configurations and operations are the same as those of the encoding device 51 shown in FIG. 1.

A decoding device corresponding to the encoding device shown in FIG. 18 is configured similarly to that shown in FIG. 13. An auxiliary information decoder 121 decodes the global motion vectors as well as the binary masks and supplies them to a substitute block detector 113. The substitute block detector 113 detects substitute blocks by performing parallel movement, enlargement, reduction of a size, and rotation on the entire screen so as to obtain the original. By this, even when the entire screen has been subjected to parallel movement, enlargement, reduction of a size, or rotation, substitute blocks are reliably detected.

The binary masks and the global motion vectors which have been decoded by the auxiliary information decoder 121 are also supplied to a texture synthesizer 122. The texture synthesizer 122 performs texture synthesis by performing parallel movement, enlargement, reduction of a size, and rotation on the entire screen so as to obtain the original. By this, even when the entire screen has been subjected to parallel movement, enlargement, reduction of a size, or rotation, the texture synthesis is reliably performed.

Other configurations and operations are the same as those of the decoding device 101 shown in FIG. 13.

As described above, when blocks adjacent to a block of interest have been encoded by the second encoding method, an image is encoded by the first encoding method using substitute blocks which are located closest to the block of interest in directions in which the block of interest and the adjacent blocks are connected to each other and which have been encoded by the first encoding method. Accordingly, deterioration of compressibility is suppressed.

In the foregoing description, the H.264/AVC method is employed as the first encoding method, the decoding method corresponding to the H.264/AVC method is employed as the first decoding method, the texture/synthesis encoding method is employed as the second encoding method, and the decoding method corresponding to the texture/synthesis encoding method is employed as the second decoding method. However, other encoding methods and decoding methods may be employed.

The series of processes described above may be executed by hardware or software. When the series of processes is executed by software, the software is installed from a program recording medium in a computer in which programs included in the software are incorporated in dedicated hardware or a general personal computer capable of executing various functions by installing various programs.

Examples of the program recording medium which stores the programs which are installed in a computer and which is executable by the computer include a magnetic disk (including a flexible disk), an optical disk (including CD-ROM (Compact Disc-Read Only Memory), a DVD (Digital Versatile Disc)), a removable medium which is a package medium including a semiconductor memory, and a ROM and a hard disk which temporarily or permanently store the programs. The programs are stored in the program recording medium using a wired or wireless communication medium such as a local area network, the Internet, or a digital satellite broadcasting through an interface such as a router and a modem where appropriate.

Note that, in this specification, steps describing programs include processes which are executed in a described order in time series, and in addition, includes processes which are executed in parallel or individually.

Furthermore, embodiments of the present invention are not limited to the embodiments described above, and various modifications may be made without departing from the scope of the invention.

1. An encoding device comprising:
a detector which detects, when adjacent blocks located adjacent to a block of interest serving as a block to be subjected to encoding of an image have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks;
a first encoder which encodes the block of interest by the first encoding method using the substitute blocks detected by the detector; and
a second encoder which encodes the block of interest which is not encoded by the first encoding method by the second encoding method.

2. The encoding device according to claim 1,
wherein, when co-located blocks which are included in pictures different from a picture including the block of interest and which are located in positions corresponding to the block of interest have been encoded by the first encoding method, the detector detects the co-located blocks as substitute blocks.

3. The encoding device according to claim 2,
wherein, when the adjacent blocks have been encoded by the first encoding method, the detector detects the adjacent blocks as substitute blocks.

4. The encoding device according to claim 3, further comprising:
a determination unit which determines whether the block of interest is encoded by the first encoding method or the second encoding method,
wherein the second encoder encodes the block of interest which is determined to be encoded by the second encoding method by the determination unit.

5. The encoding device according to claim 4,
wherein the determination unit determines blocks having parameter values representing differences between pixel values thereof and pixel values of the adjacent blocks larger than a threshold value as blocks to be encoded by the first encoding method and determines blocks having the parameter values smaller than the threshold value as blocks to be encoded by the second encoding method.

6. The encoding device according to claim 4,
wherein the determination unit determines blocks having edge information as blocks to be encoded by the first encoding method and determines blocks which do not have the edge information as blocks to be encoded by the second encoding method.

7. The encoding device according to claim 4,
wherein the determination unit determines that I pictures and P pictures are encoded by the first encoding method and B pictures are encoded by the second encoding method.

8. The encoding device according to claim 6,
wherein the determination unit determines that, among the blocks which do not have the edge information, blocks having the parameter values larger than the threshold value as blocks to be encoded by the first encoding method and the blocks having the parameter values smaller than the threshold value as blocks to be encoded by the second encoding method.

9. The encoding device according to claim 8,
wherein the determination unit determines that, among the blocks which do not have the edge information of B pictures, the blocks having the parameter values larger than the threshold value as blocks to be encoded by the first encoding method and the blocks having the parameter values smaller than the threshold value as blocks to be encoded by the second encoding method.

10. The encoding device according to claim 5,
wherein the parameters include dispersion values of pixel values included in the adjacent blocks.

11. The encoding device according to claim 10,
wherein the parameters are represented by the following expression:
$$S T V = \frac{1}{N} {\sum }_{i = 1}^{N} [ {w}_{1} δ ( {B}_{i} ) + {w}_{2} {\sum }_{{B}_{j} ∈ {μ}_{6} ( {B}_{j} )} \vert E ( {B}_{j} ) - E ( {B}_{i} ) \vert ] \qquad [ Expression 1 ]$$

12. The image encoding device according to claim 1, further comprising:
a motion vector detector which detects global motion vectors of the image,
wherein the first encoder performs encoding using the global motion vectors detected by the motion vector detector, and
the second encoder encodes the global motion vectors detected by the motion vector detector.

13. The encoding device according to claim 5,
wherein the second encoder encodes position information representing positions of the blocks having the parameter values smaller than the threshold value.

14. The image encoding device according to claim 1,
wherein the first encoding method is based on the H.264/AVC standard.

15. The image encoding device according to claim 1,
wherein the second encoding method corresponds to a texture analysis/synthesis encoding method.

16. An encoding method, comprising:
a detector;
a first encoder; and
a second encoder,
wherein the detector detects, when blocks located adjacent to a block of interest to be subjected to encoding of an image have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks,
the first encoder encodes the block of interest by the first encoding method using the substitute blocks detected by the detector, and
the second encoder encodes the block of interest which is not encoded by the first encoding method by the second encoding method.

17. A decoding device comprising:
a detector which detects, when blocks located adjacent to a block of interest to be subjected to encoding of an image have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks;
a first decoder which decodes the block of interest which has been encoded by the first encoding method by a first decoding method corresponding to the first encoding method using the substitute blocks detected by the detector; and
a second decoder which decodes the block of interest which has been encoded by the second encoding method by a second decoding method corresponding to the second encoding method.

18. The decoding device according to claim 17,
wherein the detector detects the substitute blocks in accordance with position information representing positions of blocks encoded by the second encoding method.

19. The decoding device according to claim 18,
wherein the second decoder decodes the position information by the second decoding method and synthesizes the block of interest which has been encoded by the second encoding method using an image which has been decoded by the first decoding method.

20. A decoding method, comprising:
a detector;
a first decoder; and
a second decoder,
wherein the detector detects, when blocks located adjacent to a block of interest to be subjected to encoding have been encoded by a second encoding method which is different from a first encoding method, peripheral blocks, as substitute blocks, which have been encoded by the first encoding method and which are located within a certain distance corresponding to a threshold value from the block of interest or within a certain distance corresponding to a threshold value from the adjacent blocks in directions in which the block of interest is connected to the individual adjacent blocks,
the first decoder decodes the block of interest which has been encoded by the first encoding method by a first decoding method corresponding to the first encoding method using the substitute blocks detected by the detector, and
the second decoder decodes the block of interest which has been encoded by the second encoding method by a second decoding method corresponding to the second encoding method.
